(19) United States
(12) Patent Application Publication
(10) Pub. No.: US 2007/0057922 A1
(43) Pub. Date: Mar. 15, 2007

(54) Input having concentric touch pads

(75) Inventors: Kevin L. Schultz, Raleigh, NC (US); Kelly J. Tierney, Carrboro, NC (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: International Business Machines Corporation, Armonk, NY (US)

(21) Appl. No.: 11/225,680

(22) Filed: Sep. 13, 2005

(51) Int. Cl. G09G 5/00

(52) U.S. Cl. 345/173

(57) ABSTRACT

Methods and apparatus include an input device for controlling an electronic device. The input device includes concentric touch pads. Contact with the touch pads includes tapping and/or sliding movement in order to provide signals that are processed and sent to the electronic device, which performs operations based on these inputs.

### BACKGROUND OF THE INVENTION

1. Field of the Invention

The invention generally relates to an electronic input device having touch pads.

2. Description of the Related Art

Many styles of input devices exist that enable a user to perform operations in an electronic device. For example, the input devices can include a mouse, touch pads, trackballs, buttons, switches, joysticks, slider bars and rotating or jog dials. These input devices are operated by the user to control the electronic device such as a computer, a video game, a phone, a remote control, a portable audio/video device and disc jockey equipment.

One issue regarding the input device involves its design. The design of the input device is critical for effectively controlling numerous functions of the electronic devices and navigating increasingly complex operations and graphical displays. Accordingly, the design of the input device must be easy to use, comfortable for the user, and facilitate accurate input while at the same time occupying a small space. A compact design for the input device advantageously requires less movement from the user during operation and provides other benefits such as portability. Moreover, the design can affect the number of user actions processed by the input device. For example, designs of the mouse and prior touch pads are for use with a single hand of the user and do not fully utilize all digits of the user.

Physical input controls such as dials, knobs, buttons, switches and slider bars provide intuitive operation of desired functions of the electronic device. However, the physical input controls are not adaptable for different types of applications that may be required with the electronic device. For example, buttons and switches that are mechanical in nature provide limited control with regards to making selections since the selections must be specific and discrete. Further, the physical input controls create a bulky mechanical interface that is not conducive to consumer goods or portable devices. The mechanical interface additionally increases costs to manufacture the input device and potential for premature failure of the input device.

In contrast, the mouse and the touch pad lack intuitive control for many of the desired functions associated with the electronic devices. For example, steering a vehicle in a game or editing video/music as performed on conventional equipment are not tasks that are correlated to actions typically performed with the mouse or a usual touch pad. Additionally, the mouse can be unfeasible for use with portable devices, which require an integrated input device. The mouse and current touch pads are designed to primarily allow the user to provide input for a limited number of tasks and types of tasks (i.e., moving a cursor, making a selection and scrolling) without effectively enabling the user to input intuitively numerous different functions and types of functions as may be required with the electronic devices.

Thus, there exists a need for an input device having touch pads that enable intuitive control of multiple functions of an electronic device.

### SUMMARY OF THE INVENTION

Embodiments of the invention generally relate to an input device for controlling an electronic device. The input device includes concentric touch pads. In one embodiment, the touch pads have a substantially circular shape. Contact with the touch pads includes tapping and/or sliding movement in order to provide a signal that is processed and sent to the electronic device, which performs an operation based on this input.

In one embodiment, an input device for generating commands to control an electronic device includes a center touch pad defining a substantially circular shape and an outer touch pad generally concentric with the center touch pad. Thus, the outer touch pad defines a ring shape. Further, an inactive surface at least partially surrounds the center touch pad and physically separates the center touch pad from the outer touch pad.

In another embodiment, a method of generating commands to control an electronic device includes providing an input device in communication with the electronic device. The input device includes a center touch pad, an annular touch pad disposed concentrically around the center touch pad, and an inactive surface disposed between the center touch pad and the annular touch pad. Receiving input corresponding to contact on the center touch pad with a first rotational sliding motion provides a first input signal to the electronic device to adjust a first function of the electronic device based on direction of the first rotational sliding motion. Similarly, receiving input corresponding to contacting on the annular touch pad with a second rotational sliding motion provides a second input signal to the electronic device to adjust a second function of the electronic device based on direction of the second rotational sliding motion.

In yet a further embodiment, an electronic device configured with a program for receiving and implementing control signals from an input device includes a processor and memory containing the program. The processor, when configured with the program, performs an operation responsive to receiving signals from the input device. The signals correspond to interactions with a center touch pad and an annular touch pad separate from the center touch pad and disposed concentrically around the center touch pad. The operation includes adjusting a first function of the electronic device based on receiving a first input signal due to direction of a first rotational sliding motion on the center touch pad and adjusting a second function of the electronic device based on receiving a second input signal due to direction of a second rotational sliding motion on the annular touch pad.

In still another embodiment, an input device for generating commands to control an electronic device includes first and second concentric touch pad assemblies. The first and second concentric touch pad assemblies are spaced from one another to prevent overlap. Each of the touch pad assemblies has a center touch pad separated from an annular touch pad disposed around the center touch pad.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a perspective view of a circular shaped center touch pad surrounded by a ring shaped outer touch pad according to one embodiment of the invention.

FIG. 2 is a cross section view of the center touch pad surrounded by the outer touch pad.

FIG. 3 is a top view of concentric touch pads configured as an input for a driving game according to one embodiment of the invention.

FIG. 4 is a top view of dual concentric touch pad arrangements configured as an input for a game utilizing tap of four discrete areas according to one embodiment of the invention.

FIG. 5 is a top view of a circular center touchpad for navigation and an outer ring touch pad for selecting specific options according to one embodiment of the invention.

FIG. 6 is a top view of concentric touch pads illustrating a change in graphics/configuration of the touch pads according to one embodiment of the invention.

FIG. 7 is a perspective view of a circular center touchpad for text entry and an outer ring touch pad for scrolling and selecting specific options according to one embodiment of the invention.

FIG. 8 is a top view of dual concentric touch pads configured as an input for manipulating audio tracks according to one embodiment of the invention.

FIG. 9 is a top view of concentric touch pads configured for video/music editing according to one embodiment of the invention.

FIG. 10 is a top view of various different configurations for concentric touch pads according to embodiments of the invention.

### DETAILED DESCRIPTION OF THE PREFERRED EMBODIMENTS

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Embodiments of the invention relate to electronic input devices having touch pads that include a center touch pad surrounded by a ring touch pad that is separate from the center touch pad. For some embodiments, the touch pads have a rounded shape such as a circular, oval, egg or elliptical shape. To utilize capabilities from each hand of a user or otherwise provide more input functions from the input device, the input device can utilize two or more touch pad arrangements spaced apart from one another with each of the touch pad arrangements having concentric touch pads. Examples of electronic devices utilizing the input devices disclosed herein include computers, video game controllers, phones, remote controls, portable audio/video (hereinafter, “multimedia”) devices, personal digital assistants (PDAs), music/video mixing and editing equipment, disc jockey (DJ) equipment and other consumer goods.

The touch pads can be any type of touch pad capable of sensing touch from an object such a digit (hereinafter, “finger”) or stylus. The touch pad can include one or more sensors disposed below a protective cover for detecting proximity of an object such as a finger. The sensors can be based on capacitive sensing, resistive sensing, surface acoustic wave sensing, pressure sensing (e.g., strain gauge), optical sensing or any other type of suitable sensing to detect touch. For example, the specific position of the object can be detected with capacitive sensing that employs a matrix of row and column electrodes used to detect trans-capacitance between specific electrodes or to detect an effective capacitance to virtual ground. The touch pad offers certain benefits such as being reconfigurable at any time, being capable of integration within the electronic device, and lacking bulky mechanical interfaces.

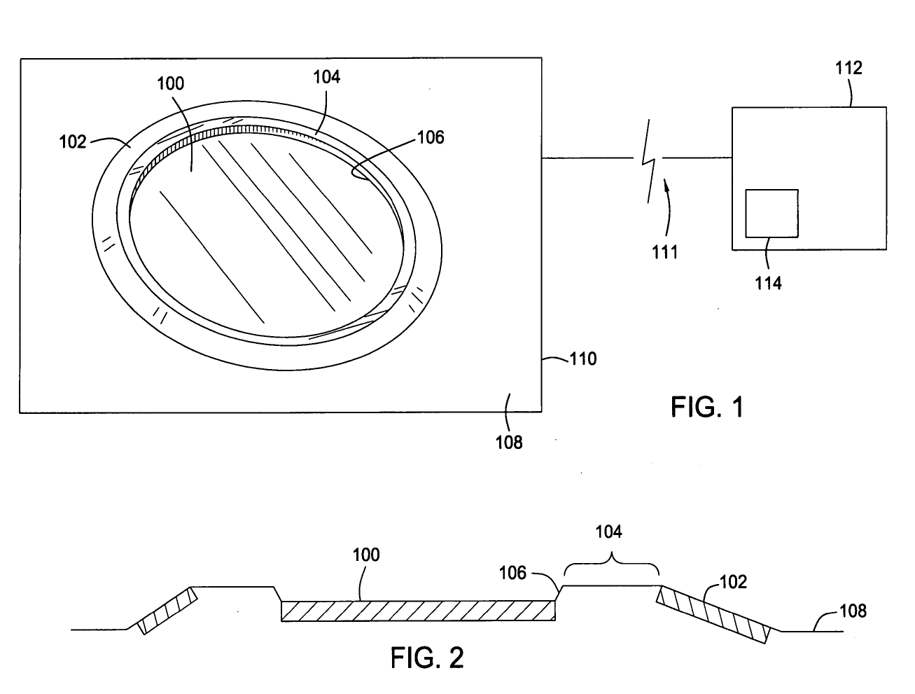

FIG. 1 illustrates a circular shaped center touch pad 100 surrounded by a ring shaped outer touch pad 102 for use with an input device 110. The input device 110 is in communication with an electronic device 112 via a connection 111. For some embodiments, the input device 110 and the electronic device 112 are integrated together. The connection 111 can be hard wired or wireless such as infrared (IR) or radio frequency (RF) based connections. Support software 114 of the electronic device can be in the form of a processor and memory containing a program. The processor when configured with the program performs steps that can include adjusting a function of the electronic device 112 based on input signals received from the input device 110.

For some embodiments, the center touch pad 100 is separated from the outer touch pad 102 by an inactive surface 104. The inactive surface 104 occupies a sufficient area to prevent unwanted input in the center touch pad 100 when a user intends to contact the outer touch pad 102, and vice-versa. Furthermore, the center touch pad 100 is recessed in some embodiments due to a lip 106 that extends upward around a perimeter of the center touch pad 100. The lip 106 assists the user in remaining within a desired input area of the center touch pad 100. The inactive surface 104 can extend parallel to the center touch pad 100 from a zenith of the lip 106 to an inside diameter of the outer touch pad 102.

For some embodiments, the outer touch pad 102 is angled to provide a surface that slopes downward from the inside diameter of the outer touch pad 102 to an outside diameter of the outer touch pad 102. A conforming portion of the user's finger tip in contact with the outer touch pad 102 is more likely to also contact the center touch pad 100 if the touch pads 100, 102 are disposed in a common flat plane. Therefore, the angle of the outer touch pad 102 further prevents unintentional touching of the center touch pad 100 when using the outer touch pad 102. Additionally, the angle of the outer touch pad 102 tends to increase surface contact by the user's finger tip. Consequently, the angle of the outer touch pad 102 enables the outer touch pad 102 to be narrower and closer to the center touch pad 100 than if the outer touch pad 102 is in a flat plane like the center touch pad 100. However, having the center touch pad 100 and the outer touch pad 102 coplanar is also contemplated.

As shown in FIG. 2, the angle of the outer touch pad 102 and depth of the lip 106 can be selected such that both of the touch pads 100, 102 are generally raised with respect to a surrounding external surface 108 of the input device. This raised configuration of the touch pads 100, 102 allows room for active layers of the touch pads 100, 102 located below surface. Further, the touch pads 100, 102 being raised enables the user's fingers to ergonomically contact the touch pads 100, 102 with less flex.

The inactive surface 104 between the touch pads 100, 102 provides a ridge that serves as a finger rest point for the user without providing any touch input to the touch pads 100, 102. Proximity of the inactive surface 104 to the touch pads 100, 102 facilitates quick and easy operation when the user thereafter desires to initiate contact on either or both of the touch pads 100, 102.

For some embodiments, the touch pads 100, 102 can detect both tap-disengage motions and sliding motions. Since the touch pads 100, 102 are circular, the touch pads 100, 102 can sense and resolve linear, angular and/or radial positions of the user's finger as it is moved in a linear, rotational and/or radial manner across the touch pads 100, 102. Therefore, the touch pads 100, 102 can allow the user to continuously swirl the finger on the touch pads 100, 102 about 360° without stopping in order to provide continuous and uninterrupted input.

For some embodiments, the outer touch pad 102 does not form a continuous touch sensitive ring. For example, the outer touch pad 102 can be broken up into one or more discrete sections (not visible) that otherwise generally provide a ring shape around the center touch pad 100 regardless of any interruptions along the outer touch pad 102. The touch pads 100, 102 offer an alternative to the physical and mechanical jog dials and slider bars on current equipment due to the circular shape of the touch pads 100, 102. In addition, the circular shape of the touch pads 100, 102 maintains all points that the user may need to contact within as compact of an area as possible. These attributes enable ease and efficiency of use of the input device utilizing the touch pads 100, 102. The following description depicts exemplary embodiments of the touch pads 100, 102 as utilized in various different configurations and input devices.

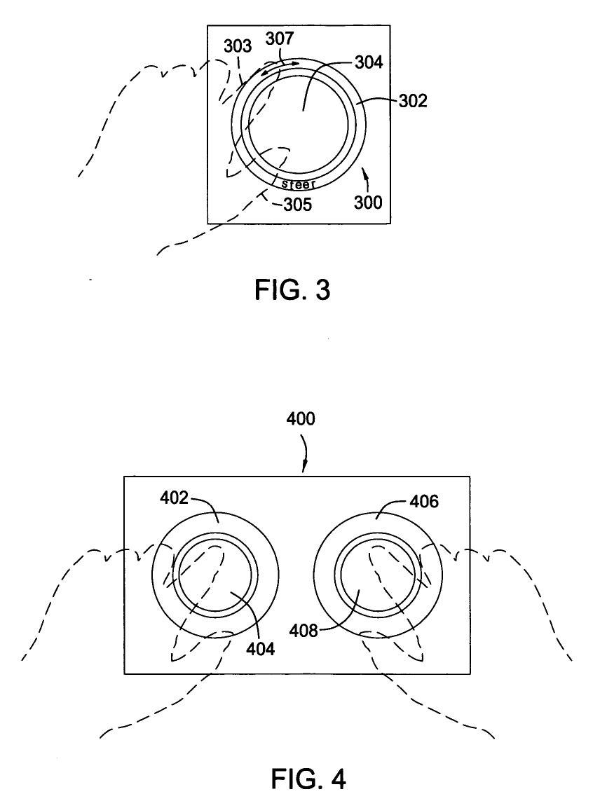

FIG. 3 illustrates concentric touch pads 300 configured as an input for controlling a driving game. An outer ring touch pad 302 provides steering input in a manner that is similar to use of a steering wheel. A first finger 303 of a user steers a vehicle (not shown) within the game by sliding movement on the outer ring touch pad 302 indicated by arrow 307. As with the steering wheel, counterclockwise rotational sliding of the first finger 303 turns the vehicle to the left while clockwise rotational sliding of the first finger 303 turns the vehicle to the right. A center touch pad 304 is configured to receive tapping input from a second finger 305 of the user in order to shift gears of the vehicle. Braking and acceleration can be provided by another input such as additional concentric touch pads (not shown) that are configured for operation with the user's other hand. Alternatively, an outer edge portion of the center touch pad 304 can be configured to receive input based on sliding movement of the second finger 305 along a right side for acceleration and a left side for braking.

FIG. 4 shows dual concentric touch pads 400 configured as an input for a game utilizing tap contact on four discrete areas. Existing video game controllers include two drums that provide input based on whether a user touches top surfaces or sides of the two drums such that there are four discrete areas available to touch for input purposes. With the dual concentric touch pads 400, the four discrete areas are provided by a first outer touch pad 402, a first center touch pad 404, a second outer touch pad 406, and a second center touch 408. The first outer and center touch pads 402, 404 are spaced from the second outer and center touch pads 406, 408 such that there is no overlap.

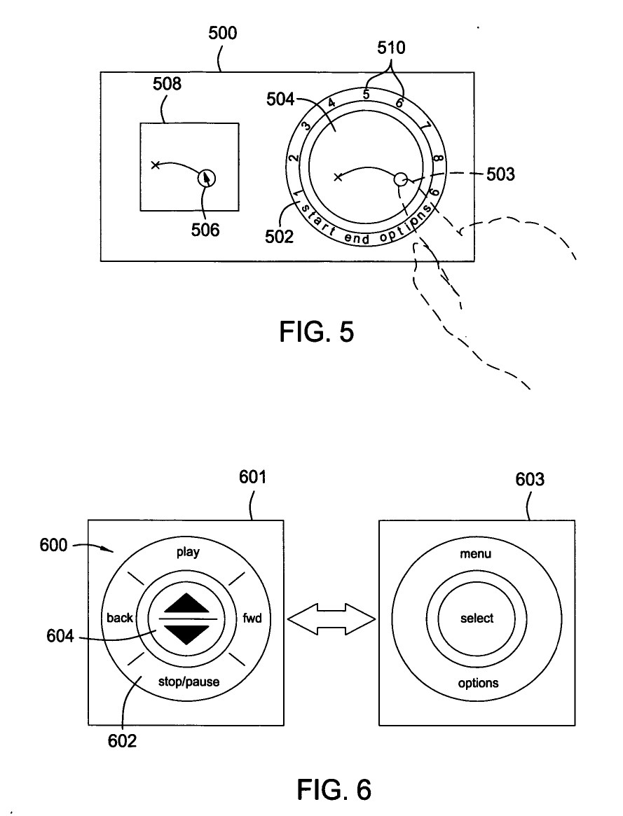

FIG. 5 illustrates a portable multimedia device 500 configured to output video and audio. For some embodiments, the device 500 includes a circular center touch pad 504 for navigation and a ring outer touch pad 502 for selecting specific options 510. Sliding motion of a user's finger 503 on the center touch pad 504 moves a cursor 506 on a screen 508. Arranged around the outer touch pad 502 are the specific options 510. By tapping one of the options 510, the user can select a particular function associated with that particular option. For example, the options 510 can be function keys, common tasks such as start, end, cut, copy, paste, add, subtract, multiply, divide and/or a numeral key pad. For some embodiments, an outer edge of the center touch pad 504 and/or one or more areas of the outer touch pad 502 can be configured to receive sliding movement of the finger 503 for scrolling.

FIG. 6 shows concentric touch pads 600 illustrating a change in graphics of the touch pads 600 between a first remote control configuration 601 and a second remote control configuration 603. For some embodiments, the change in graphics is provided by a back lit screen underlay that changes text displayed on the touch pads 600. Stickers or templates can be used to identify functions of the touch pads 600 where the change in graphics is limited and not needed to be dynamic.

This change in configuration is accomplished by processing of the contact with the touch pads 600 to alter how and what these input signals control in an electronic device. The change in graphics between the remote control configurations 601, 603 can occur based on user selection or what activity is being performed by the electronic device controlled by input from the touch pads 600. Alternatively, the change in graphics between the remote control configurations 601, 603 can occur directly following or after a set time upon execution of an input received from the touch pads 600. For example, the second remote control configuration 603 can be an initial arrangement for operating a video device prior to playing a video. Accordingly, the second remote control configuration 603 provides sliding motion for scrolling through menus and options and making selections leading up to playing of the video. Upon initiating play of the video, the change in graphics adapts to the first remote control configuration 601. With the first remote control configuration 601, a user can raise and lower volume by touching a center touch pad 604 and input play oriented commands with an outer touch pad 602. In this embodiment, the outer touch pad 602 adapts to specific applications by enabling tapping to select functions in the first remote control configuration 601 and permitting sliding motion to operate functions in the second remote control configuration 603.

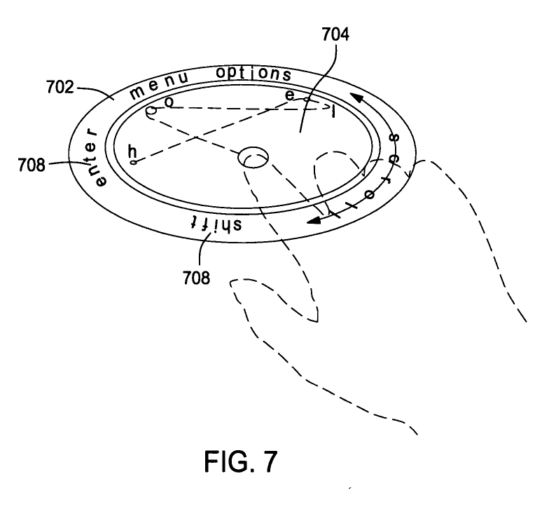

FIG. 7 illustrates a circular center touchpad 704 for text entry and a ring outer touch pad 702 having a right side area 706 for scrolling and a left side area for selecting specific options 708. The center touchpad 704 can be adapted to enter text based on continuous style key layout where letters correspond to respective locations within the center touchpad 704. A user's sliding movement to contact desired letters is processed to form words. Examples of the specific options 708 that can be employed when the circular center touchpad 704 is for text entry include shift, enter, menu and options.

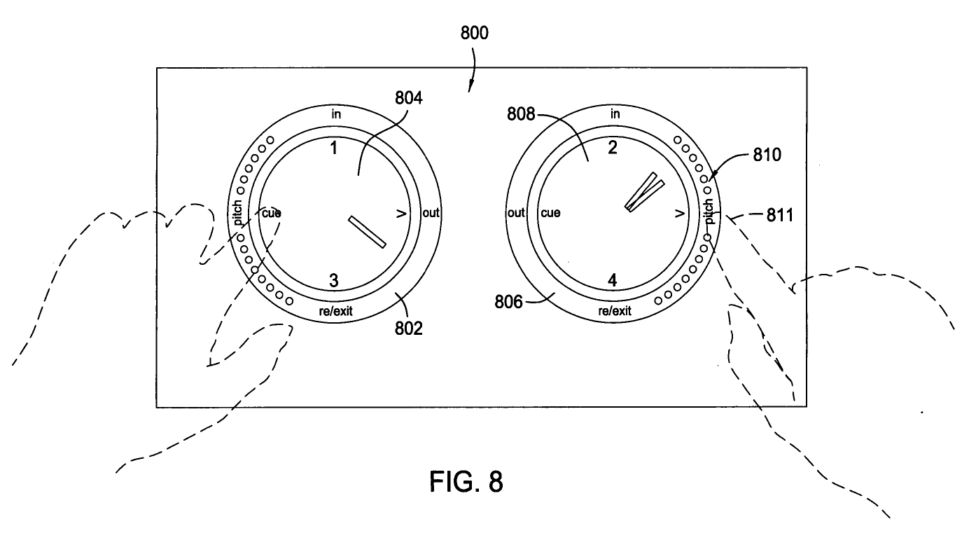

FIG. 8 shows dual concentric touch pads 800 configured as an input 800 for manipulating audio tracks. The dual concentric touch pads 800 include a first outer touch pad 802, a first center touch pad 804, a second outer touch pad 806, and a second center touch 808. The first outer and center touch pads 804, 808 are spaced from the second outer and center touch pads 806, 804 such that there is no overlap. The center touch pads 804, 808 enable a user to choose tracks or clips to bring in by tapping on corresponding numbers (illustrated as one through four at top and bottom portions of the center touch pads 804, 808) of the tracks that are desired. The track selected on the first center touch pad 804 is thereafter manipulated by the first center and outer touch pads 802, 804. Likewise, the track selected on the second center touch pad 808 is from then on manipulated by the second center and outer touch pads 806, 808. The center touch pads 804, 808 can allow the user to cue up and play/pause respective tracks by tapping appropriate side areas of the center touch pads 804, 808.

The outer touch pads 802, 806 can enable the user to tap and select options for bringing in a loop of the track, exiting/repeating the loop or taking a track out to then select a new track. Further, the outer touch pads 802, 806 can each have a region such as a right side 810 of the second outer touch pad 806 for affecting pitch of the track by sliding movement of the user's finger 811 on the second outer touch pad 806. For some embodiments, the right side 810 functions like a physical jog dial with counterclockwise and clockwise sliding movement of the finger 810 lowering or raising the pitch from an initial pitch. Rate of change to the pitch can be affected by length of the sliding movement of the finger 810 on the second outer touch pad 806 away from a point of first contact or a predefined midpoint.

Similar to the first and second remote control configurations 601, 603 described above with respect to FIG. 6, functions of the dual concentric touch pads 800 can be changed and/or a configuration can be indicated on the touch pads 800 by back lit text. For example, the right side 810 of the second outer touch pad 806 can switch configuration to a dial type input that controls fade for the track after setting the pitch or upon a predetermined time (e.g., two seconds) after bringing in the loop. As another example, the center touch pads 804, 808 can change configuration upon playing of the track to accept rotational input from the user to manipulate the audio track in a similar manner as if the rotational input was to an actual turntable playing a record. In yet a further example, the center touch pads 804, 808 can change upon playing of the track to operate as a dial with rotational peripheral sliding movement to set beats per minute for the track. The center touch pads 804, 808 can change back to an initial configuration when a selection is made on the outer touch pads 802, 806 to get out of the track.

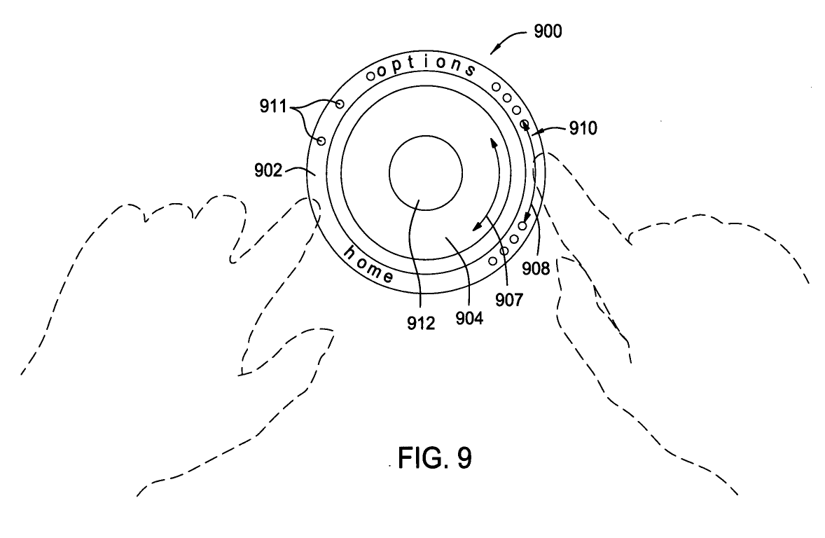

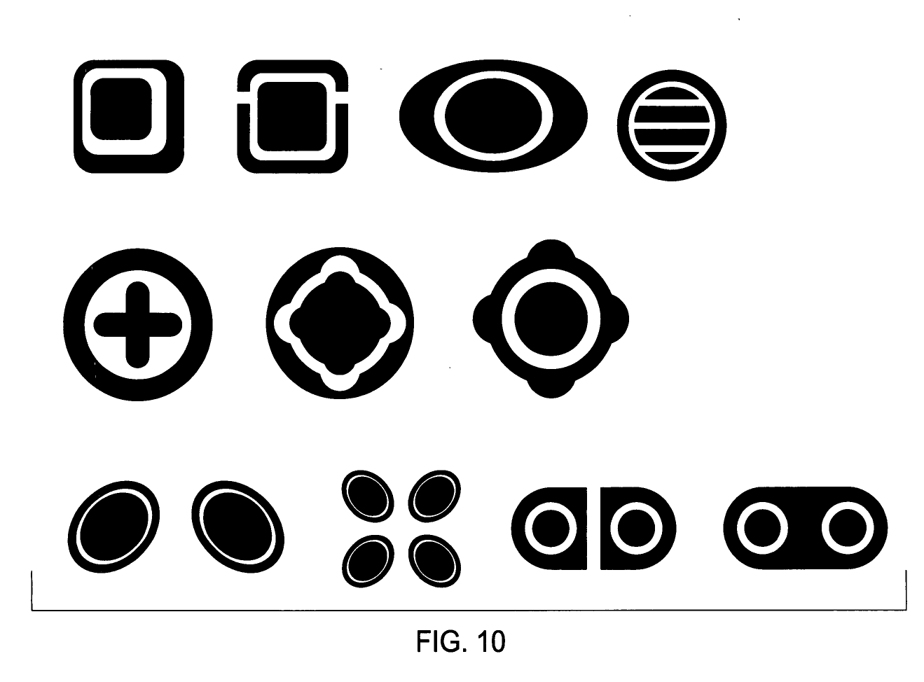

FIG. 9 illustrates concentric touch pads 900 configured for video/music editing. The concentric touch pads 900 include an outer touch pad 902 and a center touch pad 904. The center touch pad 904 enables a user to scroll through an entire reel by rotational sliding movement along a perimeter indicated by arrow 907. A middle area 912 within the center touch pad 904 can be an area that does not sense touch. The middle area 912 can be inactive and provides a suitable location for logo placement. For other embodiments, the middle area 912 can be a mechanical button or toggle.

The outer touch pad 902 can enable the user to tap and select functions 911 such as home, transition, paste, trim, edit and options. Further, the outer touch pad 902 can have a region 910 for controlling speed of a single clip by sliding movement indicated by arrow 908. For some embodiments, the region 910 of the outer touch pad 902 functions similar to a physical jog dial with counterclockwise and clockwise sliding movement increasing or decreasing the speed of the clip.

As is apparent from the foregoing, a particular arrangement of operations and functions performed with concentric touch pads as disclosed herein can vary or be rearranged to different areas of the touch pads and is not intended to be limited to those arrangements shown. Regardless of the particular arrangement, the concentric touch pads enable fast and reliable input that can include either or both tapping and sliding movement. Further, these functions and operations, wherever arranged on the concentric touch pads, can benefit from the geometric shapes of the touch pads described herein to provide intuitive functionality. For some embodiments, an input device can have more than two touch pad assemblies that each has a center touch pad and a surrounding annular touch pad.

For example, FIG. 10 diagrammatically illustrates various different configurations for concentric touch pads and their layout on an input according to embodiments of the invention. Input areas of the configurations for the concentric touch pads shown in FIG. 10 are illustrated by solid black areas. Based on these input areas, each configuration shown can have a central touch area(s) and a surrounding touch area(s) in accordance with the scope of the invention. Consequently, these alternative shapes, layout and configurations of touch pads are intended as further examples for implementation based on this disclosure.

With reference to FIG. 1 and the support software 114, code is also contemplated for implementing the input device with respect to the electronic device to which it is connected. Accordingly, routines executed to implement such embodiments of the invention, may be part of an operating system or a specific application, drivers, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

One embodiment of the invention is implemented as a program product for use with a computer system. The program(s) of the program product defines functions of the embodiments (including the methods described herein) and can be contained on a variety of computer-readable media. Illustrative computer-readable media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information to/from the Internet and other networks. Such computer-readable media, when carrying computer-readable instructions that direct the functions of the present invention, represent embodiments of the present invention.

While the foregoing is directed to embodiments of the present invention, other and further embodiments of the invention may be devised without departing from the basic scope thereof, and the scope thereof is determined by the claims that follow.

What is claimed is:

1. An input device for generating commands to control an electronic device, comprising:
a center touch pad defining a substantially circular shape;
an outer touch pad generally concentric with the center touch pad and defining a ring shape; and
an inactive surface surrounding the center touch pad and physically separating the center touch pad from the outer touch pad.

2. The input device of claim 1, wherein the touch pads and inactive surface are integrated within a portable multimedia device configured to output video and audio.

3. The input device of claim 1, wherein the outer touch pad is angled downward from an inside diameter to an outside diameter thereof.

4. The input device of claim 1, wherein the center touch pad is recessed by a lip of the inactive surface protruding upward around a perimeter of the center touch pad.

5. The input device of claim 1, wherein the center touch pad surrounds a middle area that is not a touch sensitive surface.

6. The input device of claim 1, wherein the touch pads are configured to change from a first configuration to a second configuration having one or more different input functions than the first configuration.

7. The input device of claim 1, wherein the touch pads are configured to change from a first configuration to a second configuration, wherein an area adapted to process a tap contact in the first configuration is adapted to process a sliding movement in the second configuration.

8. The input device of claim 1, wherein the touch pads are configured to change from a first configuration to a second configuration based on an action performed by the electronic device.

9. The input device of claim 1, wherein the touch pads are configured to change from a first configuration to a second configuration based on a user selection.

10. The input device of claim 1, wherein the touch pads are configured to change from a first configuration to a second configuration after a predetermined time following an event performed by the electronic device.

11. The input device of claim 1, wherein the touch pads and inactive surface are disposed on a remote control for the electronic device.

12. The input device of claim 1, wherein the touch pads and inactive surface are disposed on a video game controller.

13. An electronic device configured with a program for receiving and implementing control signals from an input device, comprising:
a processor and memory containing the program, wherein the processor when configured with the program performs an operation responsive to receiving signals from the input device, the signals corresponding to interactions with a center touch pad and an annular touch pad separate from the center touch pad and disposed concentrically around the center touch pad, the operation comprising:
adjusting a first function of the electronic device based on receiving a first input signal due to direction of a first rotational sliding motion on the center touch pad; and
adjusting a second function of the electronic device based on receiving a second input signal due to direction of a second rotational sliding motion on the annular touch pad.

14. The electronic device of claim 13, wherein the operation further comprises selecting a specific function based on receiving a third input signal due to contact with one of the touch pads with a tapping motion.

15. The electronic device of claim 13, wherein adjusting one of the functions includes in manipulating an audio track with the electronic device.

16. The electronic device of claim 13, wherein adjusting one of the functions includes manipulating a video clip with the electronic device.

17. An input device for generating commands to control an electronic device, comprising:
a first concentric touch pad assembly having a first center touch pad separated from a first annular touch pad disposed around the first center touch pad; and
a second concentric touch pad assembly having a second center touch pad separated from a second annular touch pad disposed around the second center touch pad, wherein the first and second concentric touch pad assemblies are spaced from one another to prevent overlap.

18. The input device of claim 17, wherein the first and second concentric touch pad assemblies are disposed on a handheld controller for the electronic device.

19. The input device of claim 17, wherein each of the annular touch pads are angled downward from an inside diameter to an outside diameter thereof.

20. The input device of claim 17, wherein the center touch pads are physically separated from the annular touch pads.

21. The input device of claim 17, wherein each of the center touch pads are disposed within a recess that identifies an outer boundary of each of the center touch pads.

22. A method of generating commands to control an electronic device, comprising:
providing an input device in communication with the electronic device, comprising:
a center touch pad;
an annular touch pad disposed concentrically around the center touch pad; and
an inactive surface disposed between the center touch pad and the annular touch pad;
receiving input corresponding to contact on the center touch pad with a first rotational sliding motion to provide a first input signal to the electronic device to adjust a first function of the electronic device based on direction of the first rotational sliding motion; and
receiving input corresponding to contact on the annular touch pad with a second rotational sliding motion to provide a second input signal to the electronic device to adjust a second function of the electronic device based on direction of the second rotational sliding motion.
